(19) United States
(12) Patent Application Publication
(10) Pub. No.: US 2026/0172290 A1
(43) Pub. Date: Jun. 18, 2026

(54) METHOD AND APPARATUS FOR NTN COVERAGE ENHANCEMENT WITH PUSCH DMRS BUNDLING

(71) Applicant: APPLE INC., Cupertino, CA (US)

(72) Inventors: Chunxuan Ye, San Diego, CA (US); Dawei Zhang, Saratoga, CA (US); Wei Zeng, San Diego, CA (US); Haitong Sun, Cupertino, CA (US); Hong He, San Jose, CA (US); Chunhai Yao, Beijing (CN); Idan Bar-Sade, Sunnyvale, CA (US); Wenshu Zhang, Sunnyvale, CA (US); Ankit Bhamri, Bad Nauheim (DE); Seyed Ali Akbar Fakoorian, San Diego, CA (US)

(21) Appl. No.: 19/122,355

(22) PCT Filed: Nov. 3, 2022
(86) PCT No.: PCT/CN2022/129611

§ 371 Date: Apr. 18, 2025

(51) Int. Cl. H04L 25/02; H04L 5/00; H04W 72/1268; H04W 72/21

(52) U.S. Cl. CPC H04L 25/0228; H04L 5/0051; H04W 72/1268; H04W 72/21

(57) ABSTRACT

Methods and apparatus are provided for physical uplink shared channel (PUSCH) demodulation reference signal (DMRS) bundling in a non-terrestrial network (NTN). A user equipment (UE) reports its capability of phase difference pre-compensation in NTN under timing drift or Doppler shift. A network node in an NTN transmits an indication to the UE of an uplink segmentation duration for DMRS bundling. The network node receives, from the UE in response to the indication, a UE capability report on a maximum time domain window (TDW) duration ability of the UE and a phase difference pre-compensation ability of the UE. The network node schedules a configured grant PUSCH for the UE indicating a PUSCH DMRS bundling size based on the maximum TDW duration ability of the UE, the phase difference pre-compensation ability of the UE, and the uplink segmentation duration.

### TECHNICAL FIELD

This application relates generally to wireless communication systems, including non-terrestrial network (NTN) communication.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a signaling diagram of a 4-step RACH procedure in accordance with some embodiments.

FIG. 2 illustrates a signaling diagram of a 2-step RACH procedure in accordance with some embodiments.

FIG. 3 is a flowchart illustrating a UE procedure for determining the preamble and/or RACH occasion based on a UE capability of physical uplink control channel (PUCCH) repetition of a fourth message (Msg4) Hybrid Automatic Repeat Request Acknowledge (HARQ-ACK) transmission in a random-access channel (RACH) procedure according to one embodiment.

FIG. 4 is a block diagram illustrating measurement timing during communication between a satellite and a UE according to certain embodiments.

FIG. 5 is a flow chart of a method for a UE according to one embodiment.

FIG. 6 is a flowchart of a UE procedure according to one embodiment.

FIG. 7 is a flowchart of a method for a network node in a NTN for joint channel estimation of PUSCH according to one embodiment.

FIG. 8 is flowchart of a method for a UE for joint channel estimation for PUSCH according to one embodiment.

FIG. 9 is a flowchart of a method for a network node in an NTN to perform joint channel estimation for PUSCH according to another embodiment.

FIG. 10 is a flowchart of a method for a UE for joint channel estimation for PUSCH according to another embodiment.

FIG. 11 is a method for a network node of an NTN according to one embodiment.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Certain efforts for non-terrestrial network (NTN) enhancement attempt to improve coverage and/or efficiency while considering NTN characteristics including large propagation delay and satellite movement. For example, certain efforts are directed to specifying physical uplink control channel (PUCCH) enhancements for a fourth message (Msg4) Hybrid Automatic Repeat Request Acknowledge (HARQ-ACK) transmission (e.g., repetition) in a random-access channel (RACH) procedure. Other efforts include, for example, studying demodulation reference signal (DMRS) bundling for physical uplink shared channel (PUSCH) while taking into account NTN-specifics (e.g., time-frequency pre-compensation).

For PUCCH repetition for Msg4 HARQ-ACK, options may include the UE performing repetition if configured in cell-specific manner, the UE requesting repetition and being dynamically instructed to perform repetition, the UE indicating a repetition capability and being dynamically instructed to perform repetition, and/or details for how the UE indicates repetition capability before Msg4. In certain systems, the supported number of PUCCH transmissions for Msg4 HARQ-ACK includes one transmission, two transmissions, four transmissions, and eight transmissions (i.e., {1, 2, 4, 8} transmissions). A single PUCCH transmission may be performed, if supported for single PUCCH transmission, according to a configuration/indication from a network node in the NTN (e.g., in signaling with respect to number of transmissions).

For NTN-specific PUSCH DMRS bundling, enhancements may be directed to handling a phase difference across a slot due to timing drift and/or Doppler shift (e.g., whether or how long a UE can meet phase continuity requirements in Table 6.4.2.5-1 of 3GPP Technical Specification (TS) 38.101-1 in consideration of frequency error within ±0.1 parts per million (PPM) specified in section 6.4.1 of 3GPP TS 38.101-5 and timing error specified in Table 7.1C.2-1 of 3GPP TS 38.133), whether the network may be enhanced to meet the requirement, or whether the UE may pre-compensate the phase difference.

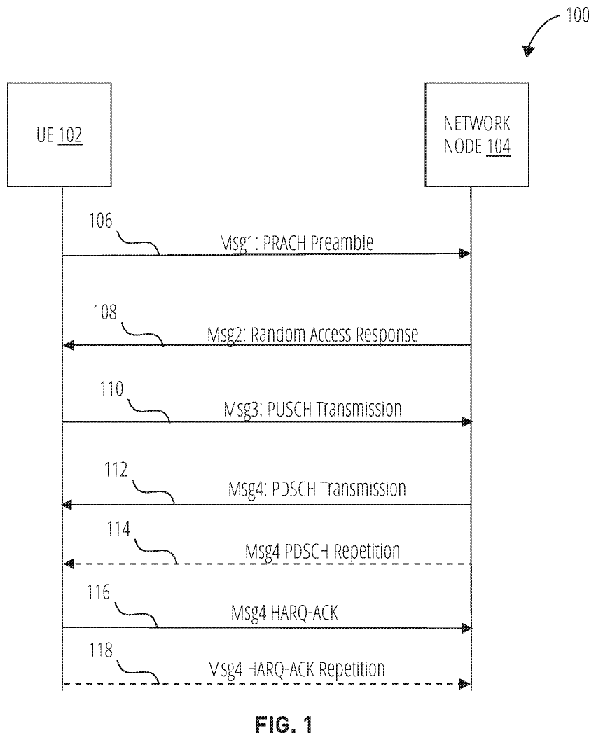

A 4-step random access channel (RACH) procedure may include at least a first message (Msg1), a second message (Msg2), a third message (Msg3), and a fourth message (Msg4) between the UE and a network node. The 4-step RACH procedure may also be referred to as Type-1 RACH. For example, FIG. 1 is a signaling diagram illustrating a RACH procedure 100 by a UE 102 and a network node 104 that may be used in certain embodiments. As shown, the UE 102 may send a Msg1 transmission 106 to the network node 104. The Msg1 transmission 106 may include a physical random access channel (PRACH) preamble including timing information for uplink transmissions.

In response to receiving Msg1 transmission 106, the network node 104 may transmit a Msg2 transmission 108 on a physical downlink control channel (PDCCH) or a physical downlink shared channel (PDSCH). The Msg2 transmission 108 may also be referred to as a random access response (RAR) message. The Msg2 transmission 108 may include timing parameters or information, an uplink grant for the Msg3 transmission 110, a temporary cell radio network temporary identifier (TC-RNTI), etc.

In response to the Msg3 transmission 110, the network node 104 may transmit a Msg4 PDSCH transmissions 112 that may include a contention resolution message. After the UE 102 sends Msg3 transmission 110, a contention resolution timer starts. The network node 104 assists the UE 102 in contention resolution using a cell radio network temporary identifier (C-RNTI) on the PDCCH or using a contention resolution identity information element (IE) on the PDSCH. The UE 102 keeps monitoring the PDCCH before the timer expires and considers the contention resolution successful and stops the timer if the UE 102 obtains the C-RNTI over the PDCCH, or the UE obtains the temporary C-RNTI over the PDCCH and a media access control (MAC) protocol data unit (PDU) is successfully decoded. If the contention resolution timer expires, the UE 102 considers the contention resolution failed.

To enhance coverage of the Msg4 PDSCH transmission 112, the network node 104 may apply repetition to the Msg4 PDSCH transmission 112. For example, the network node 104 may transmit one or more Msg4 PDSCH repetitions 114. Msg4 PDSCH repetition 114 allows the network node 104 to re-transmit the contention resolution information that was sent via the Msg4 PDSCH transmission 112 at a different time. That way, if the UE 102 fails to receive the Msg4 PDSCH transmission 112 due to interference, the UE 102 will have additional opportunities to receive the Msg4 information.

After the UE 102 receives the Msg4 PDSCH transmission 112 and any repetitions, the UE 102 may send a Msg4 HARQ-ACK 116 to the network node 104 in a physical uplink control channel (PUCCH) or a physical uplink shared channel (PUSCH). The HARQ-ACK timing may be adjusted for Msg4 PDSCH repetitions. The Msg4 HARQ-ACK 116 allows the UE 102 to provide feedback regarding the Msg4 PDSCH transmission 112. To enhance the Msg4 HARQ-ACK 116, the wireless communication system may support the UE sending one or more Msg4 HARQ-ACK repetitions 118. The Msg4 HARQ-ACK repetition 118 comprises the UE repeatedly transmitting the Msg4 HARQ-ACK on the PUCCH. That way, if the network node 104 fails to receive the Msg4 HARQ-ACK 116 due to interference, the network node 104 will have additional opportunities to receive the HARQ-ACK information.

In some embodiments, Msg4 HARQ-ACK repetition with DMRS bundling may be used to enhance Msg4. For DMRS, a time domain window (TDW) may be specified. During the TDW, a UE is expected to maintain power consistency and phase continuity among PUCCH repetitions as HARQ-ACK for Msg4.

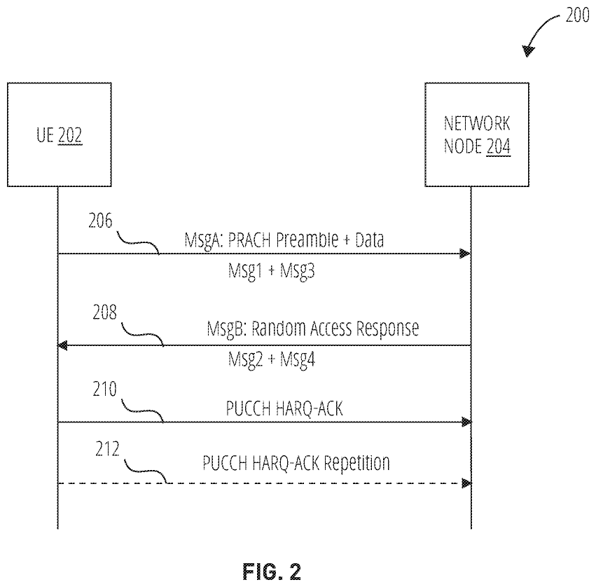

A 2-step RACH procedure may reduce the latency of the 4-step RACH procedure, and may include at least a first message (MsgA) and a second message (MsgB). The 2-step RACH procedure may also be referred to as Type-2 RACH. For example, FIG. 2 is a signaling diagram illustrating a 2-step RACH procedure 200 by a UE 202 and a network node 204 that may be used in certain embodiments. As shown, the UE 202 may send a MsgA transmission 206 to the network node 204. The MsgA transmission 206 may include the Msg1 transmission and the Msg3 transmission shown in FIG. 1. In response to receiving MsgA transmission 206, the network node 204 may transmit a MsgB transmission 208 on a physical downlink control channel (PDCCH) or a physical downlink shared channel (PDSCH). The MsgB transmission 208 may include the Msg2 transmission and the Msg4 transmission shown in FIG. 1.

After the UE 202 receives the MsgB transmission 208 (and any repetitions of the MsgB transmission 208), the UE 202 may send a PUCCH HARQ-ACK 210 to the network node 204. The PUCCH HARQ-ACK 210 allows the UE 202 to provide feedback regarding the MsgB transmission 208 (i.e., the Msg2+Msg4 transmission). To enhance the PUCCH HARQ-ACK 210, the wireless communication system may support the UE sending one or more PUCCH HARQ-ACK repetitions 212. The PUCCH HARQ-ACK repetition 212 comprises the UE 202 repeatedly transmitting the PUCCH HARQ-ACK to the network node 204. That way, if the network node 204 fails to receive the PUCCH HARQ-ACK 210 due to interference, the network node 204 will have additional opportunities to receive the HARQ-ACK information. As used herein, for simplicity, reference to Msg4 HARQ-ACK repetition may refer to PUCCH HARQ-ACK repetition for Type-2 RACH.

Certain embodiments disclosed herein provide for indicating a UE's capability of PUCCH repetition before a Msg4 PDSCH transmission (or a MsgB transmission) in a RACH procedure. The UE may further indicate the number of Msg4 HARQ-ACK repetition for each PUCCH resource set. In other embodiments, as satellites may move with respect to a UE, procedures are provided to ensure that a request of PUCCH repetition for Msg4 is valid. Further, certain embodiments, efficiently use RACH resources for UEs that do not have the capability of PUCCH repetition for Msg4. Other embodiments differentiate a UE with or without the capability of phase difference pre-compensation.

### UE Indication of the Capability of PUCCH Repetition for Msg4 HARQ-ACK

In certain embodiments, a UE sends an indication of a UE capability for a PUCCH repetition of a Msg4 HARQ-ACK transmission in a RACH procedure. In one such embodiment, the UE uses capability related signaling to indicate whether or not the UE supports PUCCH repetition of the Msg4 HARQ-ACK transmission. The UE may indicate, for example, that it supports PUCCH repetition, no matter how many repetitions are supported. Alternatively, the UE may indicate the particular number of transmissions it supports for PUCCH repetition. For example, given a supported number of transmissions as {1, 2, 4, 8} transmissions, the UE may indicate that supports one transmission and four transmissions (i.e., {1, 4} transmissions) for PUCCH repetition. This can be signaled in a bitmap of length-4 to indicate its supported transmission number. Alternatively, the UE may indicate an upper bound (i.e., maximum number) of transmissions it supports for PUCCH repetition. For example, the UE may indicate that it can support up to four PUCCH transmissions, which implies it supports {1, 2, 4} PUCCH transmissions. The UE may use a 2-bit field to indicate its supported maximum number of transmissions (e.g., “00” to indicate {1} PUCCH transmission number; “01” to indicate {1, 2} PUCCH transmissions; “10” to indicate {1, 2, 4} PUCCH transmissions; and “11” to indicate {1, 2, 4, 8} PUCCH transmissions).

In another embodiment, the UE indicates its capability via PRACH. For example, the UE 102 shown in FIG. 1 may include the indication of the UE capability in the Msg1 transmission 106. As another example, the UE 202 shown in FIG. 2 may include the indication of the UE capability in the MsgB transmission 208.

The UE may use different PRACH preambles to indicate its different capabilities on PUCCH repetition for Msg4 HARQ-ACK. For example, preambles 0-15 may indicate that the UE supports up to one PUCCH transmission, preambles 16-31 may indicate that the UE supports up to two PUCCH transmissions, preambles 32-47 may indicate that the UE supports up to four PUCCH transmissions, and preambles 48-63 may indicate that the UE supports up to eight PUCCH transmissions. In another example, preambles 0-31 may indicate that the UE does not support PUCCH repetition (i.e., only legacy PUCCH for Msg4 HARQ-ACK) and preambles 32-63 may indicate that the UE does support PUCCH repetition for Msg4 HARQ-ACK.

In another embodiment, the UE may use different RACH occasions to indicate its different capabilities on PUCCH repetition for Msg4 HARQ-ACK. A RACH occasion corresponds to time and frequency resources that are available for the reception of the PRACH. For example, the UE may send a PRACH on a first RACH occasion to indicate that it does not support PUCCH repetition (i.e., only legacy PUCCH for Msg4 HARQ-ACK) and the UE may send a PRACH on a second RACH occasion to indicate that the UE does support PUCCH repetition for Msg4 HARQ-ACK.

In another embodiment, the UE uses both different PRACH preambles and different RACH occasions to indicate its different capabilities on PUCCH repetition for Msg4 HARQ-ACK. For example, preambles 0-31 on RACH occasions 0-31 may indicate that the UE supports up to one PUCCH transmission, preambles 0-31 on RACH occasions 32-63 may indicate that the UE supports up to two PUCCH transmissions, preambles 32-63 on RACH occasions 0-31 may indicate that the UE supports up to four PUCCH, and preambles 32-63 on RACH occasions 32-63 may indicate that the UE supports up to eight PUCCH. The mapping between the UE's PUCCH repetition capability and PRACH preamble/RACH occasion may be broadcast in a system information block (SIB). For example, system information block type 1 (SIB1), system information block type 19 (SIB19), or a new SIB type associated with NTN communication may be used to indicate the mapping. The UE may read the SIB first and then, based on its capability, determine which set of preamble and RACH occasion to use for the transmissions of PRACH.

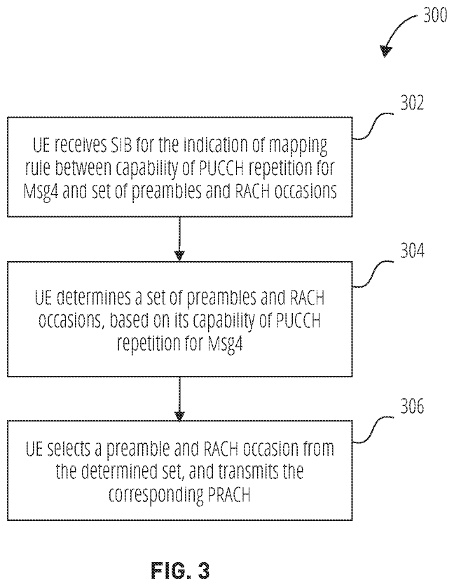

FIG. 3 is a flowchart of an example UE method 300 of determining the preamble and/or RACH occasion based on a UE capability according to one embodiment. At block 302, the UE receives an SIB for the indication of a mapping rule between a capability of PUCCH repetition of a Msg4 HARQ-ACK transmission in a RACH procedure and a set of preambles and RACH occasions. At block 304, the UE determines a set of preambles and RACH occasions, based on its capability of PUCCH repetition for Msg4. At block 306, the UE selects a preamble and RACH occasion from the determined set, and transmits the corresponding PRACH.

In another embodiment, the UE indicates its capability of PUCCH repetition for Msg4 HARQ-ACK via Msg3 PUSCH (see FIG. 1) or MsgA PUSCH (see FIG. 2) in a RACH procedure. Different sets of UE contention resolution identifiers (IDs) may be used to indicate different UE's capabilities of PUCCH repetition.

In another embodiment, a UE capability and triggering of PUCCH repetition for Msg4 HARQ-ACK is jointly indicated. The UE may transmit the dedicated preamble and/or on a dedicated RACH occasion only when the UE has the capability of PUCCH repetition and when the UE determines that PUCCH repetition is needed. This may, for example, be based on whether the measured synchronization signal block (SSB) reference signal received power (RSRP) is below a threshold. Otherwise, if the UE is not capable of PUCCH repletion or the UE determined that PUCCH repetition is not needed, the UE does not transmit the dedicated preamble and/or on the dedicated RACH occasion to trigger PUCCH repetition for Msg4 HARQ-ACK.

In another embodiment, the UE indicates the capability of PUCCH repetition for Msg4 via a media access control (MAC) control element (CE). In one such embodiment, a new MAC CE associated with NTN communication is introduced for capability indication and a bitmap may be used to indicate a supported repetition number. In another embodiment, an existing MAC CE is used wherein a reserved bit is reused to indicate this capability. The MAC CE may be carried, for example, in Msg3 PUSCH or MsgA PUSCH.

### Indication of Repetition Number for PUCCH for Msg4 HARQ-ACK

Once a network node receives a UE's request for PUCCH repetition for Msg4 HARQ-ACK, the network node decides whether to schedule PUCCH repetition for Msg4 HARQ-ACK, as well as how many PUCCH repetitions are applied. Certain embodiments disclosed herein support this dynamic indication of PUCCH repetition for Msg4 HARQ-ACK.

In one embodiment, the network node provides an indication to the UE of a repetition number for PUCCH Msg4 HARQ-ACK. One such embodiment reuses predefined cell-specific PUCCH resource sets. See, for example, Table 9.2.1-1 in 3GPP TS 38.213, where DCI 1_0 for Msg4 PDSCH may indicate the number of PUCCH repetitions for Msg4 HARQ-ACK. The IE of PUCCH-ConfigCommon may be reused such that a single parameter of pucch-ResourceCommon is used to indicate the PUCCH resource set for both NTN and terrestrial network (TN). Alternatively, the IE of PUCCH-ConfigCommon may be modified with a new parameter of pucch-ResourceCommonNTN to indicate the PUCCH resource set for NTN and the existing parameter of pucch-ResourceCommon may be used to indicate the PUCCH resource set for TN.

Another embodiment modifies an existing predefined cell-specific PUCCH resource set, such as Table 9.2.1-1 in 3GPP TS 38.213. For example, a new column may be added to the table to indicate the number of repetitions for each PUCCH resource set. The IE of PUCCH-ConfigCommon may be reused or modified, as discussed above. Alternatively, several new rows may be added to the table for NTN to indicate that the number of repetitions is larger than one (which is a modification of the IE PUCCH-ConfigCommon).

Another embodiment adds new predefined cell-specific PUCCH resource sets. For example, a new table may include the number of repetitions for each PUCCH resource set (which is a modification of the IE PUCCH-ConfigCommon).

### Timeline of SSB Measurement

In certain embodiments, an SSB-RSRP measurement may be considered as a triggering condition of PUCCH repetition for Msg4 HARQ-ACK. For example, when the SSB-RSRP measurement is below a threshold value, the UE may determine that channel conditions between the UE and the network node are degraded such that PUCCH repetition for Msg4 HARQ-ACK may be needed to increase the likelihood of adequate feedback. However, for NTN, movement of the network node with respect to a UE may reduce the usefulness of the SSB-RSRP measurement as the triggering condition.

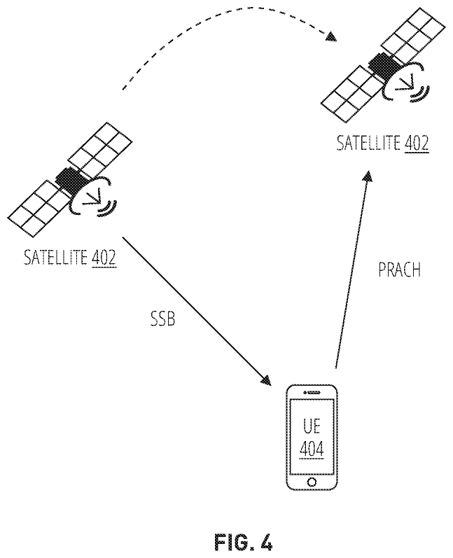

For example, FIG. 4 is a block diagram illustrating measurement timing during communication between a satellite 402 and a UE 404 according to certain embodiments. At a first time when the satellite 402 is at a first location with respect to the UE 404, the UE 404 may receive and perform an RSRP measurement of an SSB from the satellite 402. At a second time when the satellite 402 is at a second location with respect to the UE 404, the UE 404 may initiate a RACH process by sending a PRACH to the satellite 402. However, because the moving satellite 402 has changed from the first location to the second location with respect to the UE 404 the channel conditions may have improved or worsened from the first time when the SSB was received to the second time when the PRACH was sent.

Thus, in certain embodiments, the UE 404 is not expected to use an SSB-RSRP measurement that is X milliseconds before the transmission of the PRACH. The value of X may be configured by the network via, for example, SIB1 or SIB19 or a new SIB associated with NTN communication.

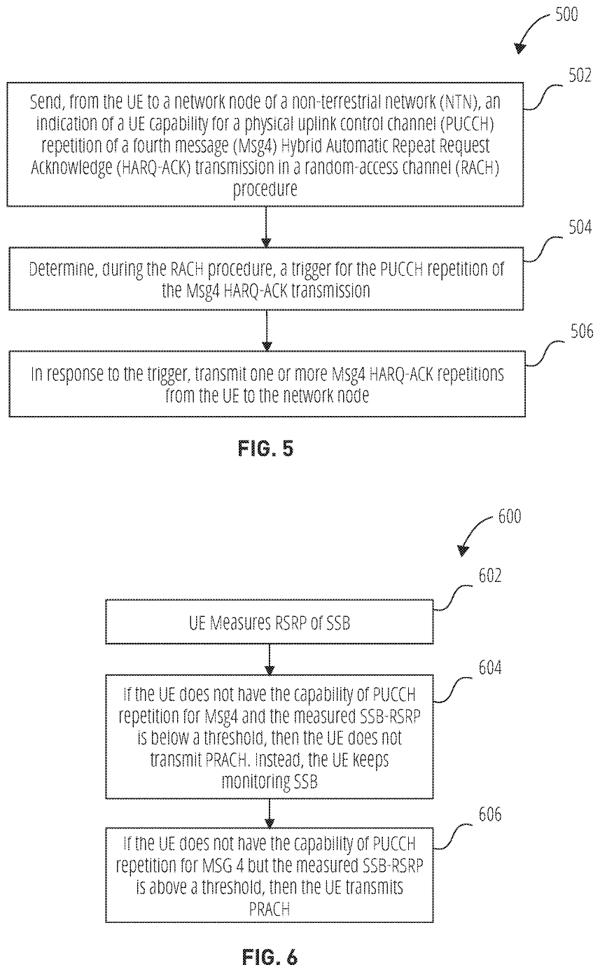

FIG. 5 is a flow chart of a method 500 for a UE according to one embodiment. In block 502, the method 500 includes sending, from the UE to a network node of a non-terrestrial network (NTN), an indication of a UE capability for a physical uplink control channel (PUCCH) repetition of a fourth message (Msg4) Hybrid Automatic Repeat Request Acknowledge (HARQ-ACK) transmission in a random-access channel (RACH) procedure. In block 504, the method 500 includes determining, during the RACH procedure, a trigger for the PUCCH repetition of the Msg4 HARQ-ACK transmission. In block 506, in response to the trigger, the method 500 includes transmitting one or more Msg4 HARQ-ACK repetitions from the UE to the network node.

In certain embodiments of the method 500, sending the indication comprises sending a capability signal from the UE to the network node. For example, the capability signal may indicate whether or not the UE supports the PUCCH repetition of the Msg4 HARQ-ACK transmission. Alternatively, the capability signal may indicate a number of transmissions supported by the UE for the PUCCH repetition of the Msg4 HARQ-ACK transmission, wherein the capability signal may comprises a four-bit bitmap to indicate the number of transmissions. In other embodiments, the capability signal indicates an upper bound of a number of transmissions supported by the UE for the PUCCH repetition of the Msg4 HARQ-ACK transmission, and the capability signal may comprise a two-bit bitmap to indicate the upper bound of the number of transmissions.

In certain embodiments of the method 500, sending the indication comprises sending a physical random access channel (PRACH) message from the UE to the network node in the RACH procedure. For example, the method 500 may further comprise using PRACH preambles to indicate different UE capabilities for the PUCCH repetition of the Msg4 HARQ-ACK transmission. In addition, or in other embodiments, the method 500 may further comprise using RACH occasions to indicate the different UE capabilities for the PUCCH repetition of the Msg4 HARQ-ACK transmission.

In certain embodiments, the method 500 further includes: receiving, at the UE, a system information block (SIB) comprising a mapping rule between the different UE capabilities for the PUCCH repetition of the Msg4 HARQ-ACK transmission and a plurality of sets of the PRACH preambles and the RACH occasions; determining a particular set of the plurality of sets of the PRACH preambles and the RACH occasions based on the UE capability for the PUCCH repetition of the Msg4 HARQ-ACK transmission, selecting a particular PRACH preamble and a particular RACH occasion from the particular set; and transmitting, from the UE to the network node, the PRACH message using the particular PRACH preamble and the particular RACH occasion for the RACH procedure. In certain such embodiments, the PRACH message is one of a first message (Msg1) transmission from the UE to the network node in a Type-1 random access procedure or a message A (MsgA) transmission from the UE to the network node in a Type-2 random access procedure. In certain embodiments, the SIB is selected from a group comprising a system information block type 1 (SIB1), a system information block type 19 (SIB19), and a system information block type associated with NTN communication.

In certain embodiments of the method 500, sending the indication comprises sending the indication in a third message (Msg3) physical uplink shared channel (PUSCH) transmission in a Type-1 random access channel procedure or a message A (MsgA) PUSCH transmission in a Type-2 random access channel procedure. Different sets of UE contention resolution identifiers (IDs) may indicate different UE capabilities for the PUCCH repetition of the Msg4 HARQ-ACK transmission.

In certain embodiments of the method 500, the indication comprises a joint indication of the UE capability for the PUCCH repetition of the Msg4 HARQ-ACK transmission and the trigger of the PUCCH repetition of the Msg4 HARQ-ACK transmission. The method 500 may further include transmitting at least one of a dedicated preamble and a dedicated RACH occasion corresponding to the joint indication only when the UE has the UE capability for the PUCCH repetition of the Msg4 HARQ-ACK transmission and the UE determines the trigger.

In certain embodiments of the method 500, sending the indication comprises sending the indication via a media access control (MAC) control element (CE) comprising a bitmap configured to indicate a supported repetition number or a reserved bit to indicate the UE capability for the PUCCH repetition of the Msg4 HARQ-ACK transmission.

In certain embodiments of the method 500, sending the indication comprises sending the indication via a media access control (MAC) control element (CE) carried in a third message (Msg3) physical uplink shared channel (PUSCH) transmission in a Type-1 random access procedure or a message A (MsgA) PUSCH transmission in a Type-2 random access procedure.

In certain embodiments, the method 500 further includes receiving, from the network node at the UE, a repetition number for the PUCCH repetition of the Msg4 HARQ-ACK transmission.

In certain embodiments of the method 500, the UE determines the repetition number by reusing predefined cell-specific PUCCH resource sets, and a downlink control information (DCI) format for an Msg4 physical downlink shared channel (PDSCH) transmission indicates the repetition number for the PUCCH repetition of the Msg4 HARQ-ACK transmission.

In certain embodiments of the method 500, the UE determines the repetition number from modified existing predefined cell-specific PUCCH resource sets, and a new column in a table corresponding to the existing predefined cell-specific PUCCH resource sets indicates the repetition number for each PUCCH resource in the existing predefined cell-specific PUCCH resource sets.

In certain embodiments of the method 500, the UE determines the repetition number from modified existing predefined cell-specific PUCCH resource sets, and a plurality of new rows in a table corresponding to the existing predefined cell-specific PUCCH resource sets for the NTN indicates the repetition number for each PUCCH resource set in the existing predefined cell-specific PUCCH resource sets is larger than one.

In certain embodiments of the method 500, the UE determines the repetition number from new predefined cell-specific PUCCH resource sets, and a new table indicates the repetition number for each PUCCH resource set in the new predefined cell-specific PUCCH resource sets.

In certain embodiments of the method 500, a PUCCH-ConfigCommon information element (IE) is reused to include a single parameter of pucch-ResourceCommon that indicates a PUCCH resource set for both the NTN and a terrestrial network (TN).

In certain embodiments of the method 500, a PUCCH-ConfigCommon information element (IE) is modified with a first parameter of pucch-ResourceCommon to indicate a first PUCCH resource set for a terrestrial network (TN) and a second parameter of pucch-ResourceCommonNTN is used to indicate a second PUCCH resource set for the NTN.

In certain embodiments of the method 500, determining the trigger comprises: measuring, at the UE, a synchronization signal block (SSB) from the network node to obtain an SSB reference signal received power (RSRP) measurement at a first time; and in response to the SSB RSRP measurement being below a threshold value: using the SSB RSRP measurement as the trigger when a physical random access channel (PRACH) message from the UE to the network node in the RACH procedure at a second time is within a predetermined elapsed time from the first time; and not using the SSB RSRP measurement as the trigger when the PRACH message at the second time is not within the predetermined elapsed time from the first time. The predetermined elapsed time may be configured by the network node using a system information block (SIB) selected from a group comprising a system information block type 1 (SIB1), a system information block type 19 (SIB19), and a system information block type associated with NTN communication.

### UEs Without a Capability of PUCCH Repetition for Msg4 HARQ-ACK

Certain embodiments provide solutions for a UE that does not have a capability of PUCCH repetition for Msg4 HARQ-ACK. If the UE does not have the capability of PUCCH repetition for Msg4 HARQ-ACK, the UE is unlikely to have a successful RACH procedure when the channel condition between the satellite and UE is poor. Thus, the use of transmission resources for initial access may be a waste of resources and power. Instead, the UE may wait until the channel condition improves before starting the RACH procedure. In one embodiment, the UE may determine whether to transmit PRACH based on the SSB-RSRP measurement. If the SSB-RSRP measurement is above a threshold, then the UE may transmit PRACH, assuming the possibility of successfully delivering PUCCH for Msg4 HARQ-ACK. If the SSB-RSRP measurement is below the threshold, then the UE may determine not to transmit PRACH. Instead, the UE may keep monitoring the SSB.

For example, FIG. 6 is a flowchart of a UE method 600 according to one embodiment. At block 602, the UE measures the RSRP of an SSB from a network node in an NTN. At block 604, if the UE does not have the capability of PUCCH repetition for Msg4 and the measured SSB-RSRP may be below a threshold, then the UE may not transmit PRACH. Instead, the UE may keep monitoring the SSB. At block 606, if the UE does not have the capability of PUCCH repetition for Msg4 but the measured SSB-RSRP is above a threshold, then the UE transmits PRACH.

Another example method for a UE includes: configuring the UE to perform a random-access channel (RACH) procedure without a capability for a physical uplink control channel (PUCCH) repetition of a fourth message (Msg4) Hybrid Automatic Repeat Request Acknowledge (HARQ-ACK) transmission; measuring, at the UE, a reference signal received power (RSRP) of a synchronization signal block (SSB) signal from a network node to obtain an SSB-RSRP measurement; when the SSB-RSRP measurement is below a threshold value, continuing to monitor the SSB signal from the network node without transmitting a physical random access channel (PRACH) message from the UE to the network node in the RACH procedure; and when the SSB-RSRP measurement is at or above the threshold value, transmitting the PRACH message from the UE to the network node in the RACH procedure,

### PUSCH DMRS Bundling for UE With Different Capabilities

In certain embodiments, the UE reports its capability of phase difference pre-compensation in NTN under timing drift and/or Doppler shift. This capability may be reported jointly or independently of its capability reporting of demodulation reference signal (DMRS) bundling. The reported capability may further describe the maximum value of phase difference that the UE can pre-compensate. The capability reporting may be in either radio resource control (RRC) signaling or MAC CE. For example, a new MAC CE may be introduced for capability indication or an existing MAC CE may include a reserved bit that is reused to indicate this capability.

In one embodiment, the network schedules the configured grant PUSCH for the UE, which may indicate the DMRS bundling (i.e., TDW) size, based on the UE capability of maximum TDW duration and the UE capability of phase difference pre-compensation, and uplink segmented transmission duration. The network performs joint channel estimation, based on the indicated TDW for PUSCH DMRS bundling.

In another embodiment, the network schedules the configured grant PUSCH for the UE, which may indicate the DMRS bundling (i.e., TDW) size, based on the UE capability of maximum TDW duration, and uplink segmented transmission duration. The network performs joint channel estimation, based on the indicated TDW for PUSCH DMRS bundling and the reported UE capability of phase difference pre-compensation.

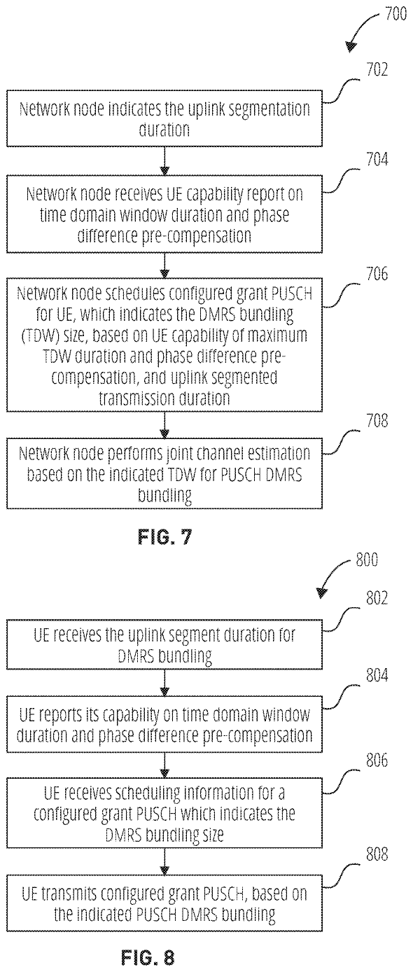

FIG. 7 is a flowchart of a method 700 for a network node in a NTN for joint channel estimation of PUSCH according to one embodiment. At block 702, the method 700 includes transmitting an indication, from the network node to a user equipment (UE), of an uplink segmentation duration for DMRS bundling. At block 704, the method 700 includes receiving, at the network node from the UE in response to the indication, a UE capability report on a maximum time domain window (TDW) duration ability of the UE and a phase difference pre-compensation ability of the UE. At block 706, the method 700 includes scheduling a configured grant PUSCH for the UE, which indicates a PUSCH DMRS bundling size based on the maximum TDW duration ability of the UE, the phase difference pre-compensation ability of the UE, and the uplink segmentation duration. At block 708, the method 700 includes performing joint channel estimation based on the PUSCH DMRS bundling size.

In one embodiment of the method 700, the UE capability report further indicates the UE's ability for the DMRS bundling.

In one embodiment, the method 700 further includes receiving an independent report of the UE's capability for the DMRS bundling.

In one embodiment of the method 700, the UE capability report further includes a maximum value corresponding to the phase difference pre-compensation ability of the UE.

In one embodiment of the method 700, the UE capability report is received in RRC signaling.

In one embodiment of the method 700, the UE capability report is received in a MAC CE configured to report a capability of phase difference pre-compensation in the NTN under at least one of timing drift and Doppler shift.

In one embodiment of the method 700, the UE capability report is received in a MAC CE comprising a reserved bit to indicate the phase difference pre-compensation ability of the UE.

FIG. 8 is flowchart of a method 800 for a UE for joint channel estimation for PUSCH according to one embodiment. At block 802, the method 800 includes receiving, from a network node in an NTN, an uplink segmentation duration for DMRS bundling. At block 804, the method 800 includes reporting, from the UE to the network node, a UE capability for a maximum time domain window (TDW) duration and a phase difference pre-compensation. At block 806, the method 800 includes receiving, from the network node, scheduling information for a configured grant PUSCH, which indicates a PUSCH DMRS bundling size. At block 808, the method 800 includes transmitting, from the UE to the network node, the configured grant PUSCH based on the PUSCH DMRS bundling size indicated by the network node.

In one embodiment of the method 800, reporting the UE capability further comprises jointly reporting the UE's ability for the DMRS bundling.

In one embodiment, the method 800 further includes sending, from the UE to the network node, an independent report of the UE's capability for the DMRS bundling.

In one embodiment of the method 800, the UE capability reported from the UE to the network node further includes a maximum value of the phase difference pre-compensation.

In one embodiment of the method 800, reporting the UE capability comprises sending, from the UE to the network node, the UE capability in RRC signaling.

In one embodiment of the method 800, reporting the UE capability comprises sending, from the UE to the network node, a MAC CE configured to report a capability of the phase difference pre-compensation in the NTN under at least one of timing drift and Doppler shift.

In one embodiment of the method 800, reporting the UE capability comprises sending, from the UE to the network node, a MAC CE comprising a reserved bit to indicate an ability by the UE to perform the phase difference pre-compensation.

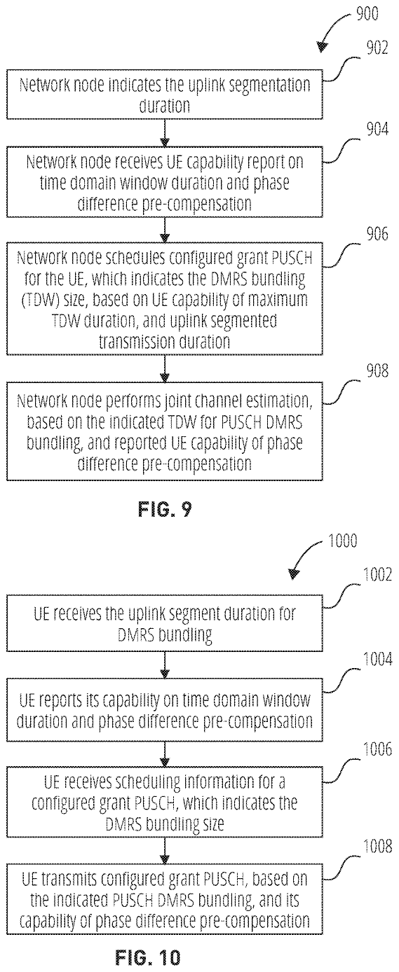

FIG. 9 is a flowchart of a method 900 for a network node in an NTN to perform joint channel estimation for PUSCH according to another embodiment. At block 902, the method 900 includes transmitting an indication, from the network node to a UE, of an uplink segmentation duration for DMRS bundling. At block 904, the method 900 includes receiving, at the network node from the UE in response to the indication, a UE capability report on a maximum time domain window (TDW) duration ability of the UE and a phase difference pre-compensation ability of the UE. At block 906, the method 900 includes scheduling a configured grant PUSCH for the UE indicating a PUSCH DMRS bundling size based on the maximum TDW duration ability of the UE and the uplink segmentation duration. At block 908, the method 900 includes performing joint channel estimation based on the PUSCH DMRS bundling size and the phase difference pre-compensation ability reported by the UE.

In one embodiment of the method 900, the UE capability report further indicates the UE's ability for the DMRS bundling.

In one embodiment, the method 900 further includes receiving an independent report of the UE's capability for the DMRS bundling.

In one embodiment of the method 900, the UE capability report further includes a maximum value corresponding to the phase difference pre-compensation ability of the UE.

In one embodiment of the method 900, the UE capability report is received in RRC signaling.

In one embodiment of the method 900, the UE capability report is received in a MAC CE configured to report a capability of phase difference pre-compensation in the NTN under at least one of timing drift and Doppler shift.

In one embodiment of the method 900, the UE capability report is received in a MAC CE comprising a reserved bit to indicate the phase difference pre-compensation ability of the UE.

FIG. 10 is a flowchart of a method 1000 for a UE for joint channel estimation for PUSCH according to another embodiment. At block 1002, the method 1000 includes receiving, at the UE from a network node in an NTN, an uplink segmentation duration for demodulation reference signal (DMRS) bundling. At block 1004, the method 1000 includes reporting, from the UE to the network node, a UE capability for a maximum time domain window (TDW) duration and a phase difference pre-compensation. At block 1006, the method 1000 includes receiving, at the UE from the network node, scheduling information for a configured grant PUSCH indicating a PUSCH DMRS bundling size. At block 1008, the method 1000 includes transmitting, from the UE to the network node, the configured grant PUSCH based on the PUSCH DMRS bundling size indicated by the network node and the UE capability for phase difference pre-compensation.

In one embodiment of the method 1000, reporting the UE capability further comprises jointly reporting the UE's ability for the DMRS bundling.

In one embodiment, the method 1000 further includes sending, from the UE to the network node, an independent report of the UE's capability for the DMRS bundling.

In one embodiment of the method 1000, the UE capability reported from the UE to the network node further includes a maximum value of the phase difference pre-compensation.

In one embodiment of the method 1000, reporting the UE capability comprises sending, from the UE to the network node, the UE capability in RRC signaling.

In one embodiment of the method 1000, reporting the UE capability comprises sending, from the UE to the network node, a MAC CE configured to report a capability of the phase difference pre-compensation in the NTN under at least one of timing drift and Doppler shift.

In one embodiment of the method 1000, reporting the UE capability comprises sending, from the UE to the network node, a MAC CE comprising a reserved bit to indicate an ability by the UE to perform the phase difference pre-compensation.

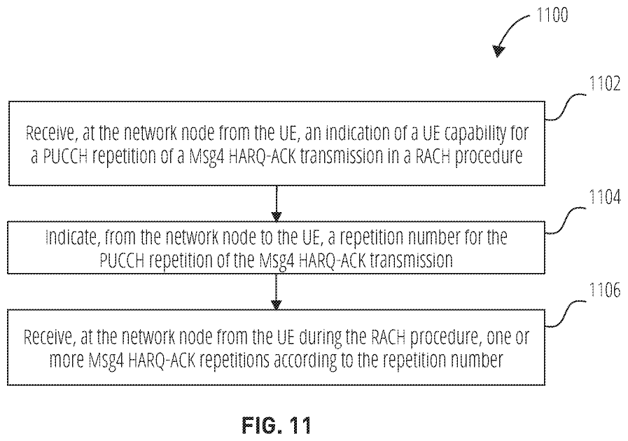

FIG. 11 is a method 1100 for a network node of an NTN according to one embodiment. In block 1102, the method 1100 includes receiving, at the network node from a UE, an indication of a UE capability for a PUCCH repetition of a Msg4 HARQ-ACK transmission in a RACH procedure. In block 1104, the method 1100 includes indicating, from the network node to the UE, a repetition number for the PUCCH repetition of the Msg4 HARQ-ACK transmission. In block 1106, the method 1100 includes receiving, at the network node from the UE during the RACH procedure, one or more Msg4 HARQ-ACK repetitions according to the repetition number.

In one embodiment of the method 1100, indicating the repetition number comprises reusing predefined cell-specific PUCCH resource sets, and a downlink control information (DCI) format for an Msg4 physical downlink shared channel (PDSCH) transmission indicates the repetition number for the PUCCH repetition of the Msg4 HARQ-ACK transmission.

In one embodiment of the method 1100, indicating the repetition number comprises modifying existing predefined cell-specific PUCCH resource sets, and a new column in a table corresponding to the existing predefined cell-specific PUCCH resource sets indicates the repetition number for each PUCCH resource in the existing predefined cell-specific PUCCH resource sets.

In one embodiment of the method 1100, indicating the repetition number comprises modifying existing predefined cell-specific PUCCH resource sets, and a plurality of new rows in a table corresponding to the existing predefined cell-specific PUCCH resource sets for the NTN indicates the repetition number for each PUCCH resource in the existing predefined cell-specific PUCCH resource sets is larger than one.

In one embodiment of the method 1100, indicating the repetition number comprises using new predefined cell-specific PUCCH resource sets, and a new table indicates the repetition number for each PUCCH resource in the new predefined cell-specific PUCCH resource sets.

In certain embodiments of the method 1100, a PUCCH-ConfigCommon information element (IE) is reused to include a single parameter of pucch-ResourceCommon that indicates a PUCCH resource set for both the NTN and a terrestrial network (TN).

In certain embodiments of the method 1100, a PUCCH-ConfigCommon information element (IE) is modified with a first parameter of pucch-ResourceCommon to indicate a first PUCCH resource set for a terrestrial network (TN) and a second parameter of pucch-ResourceCommonNTN is used to indicate a second PUCCH resource set for the NTN.

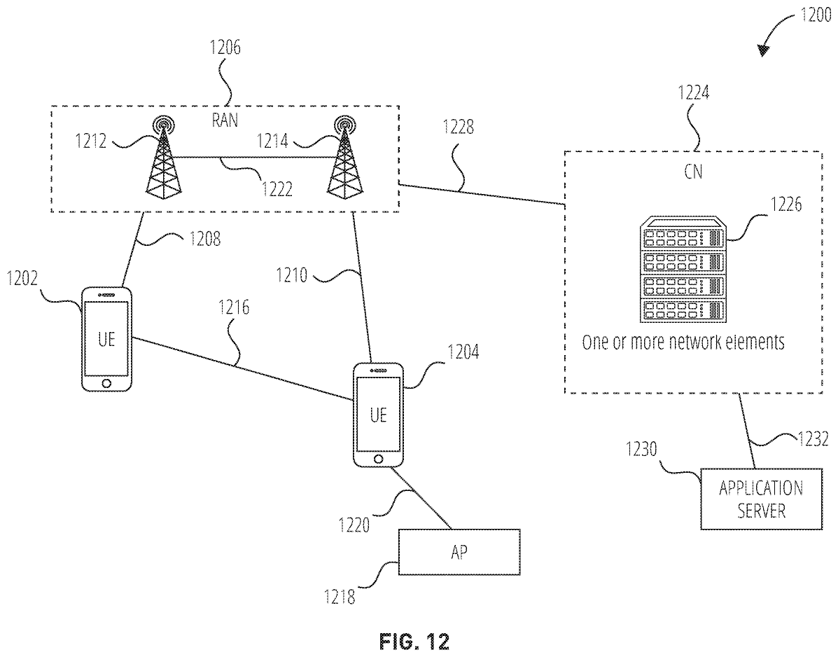

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations (such as base station 1212 and base station 1214) that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VoIP sessions, group communication sessions, etc.) for the UE 1202 and UE 1204 via the CN 1224. The application server 1230 may communicate with the CN 1224 through an IP communications interface 1232.

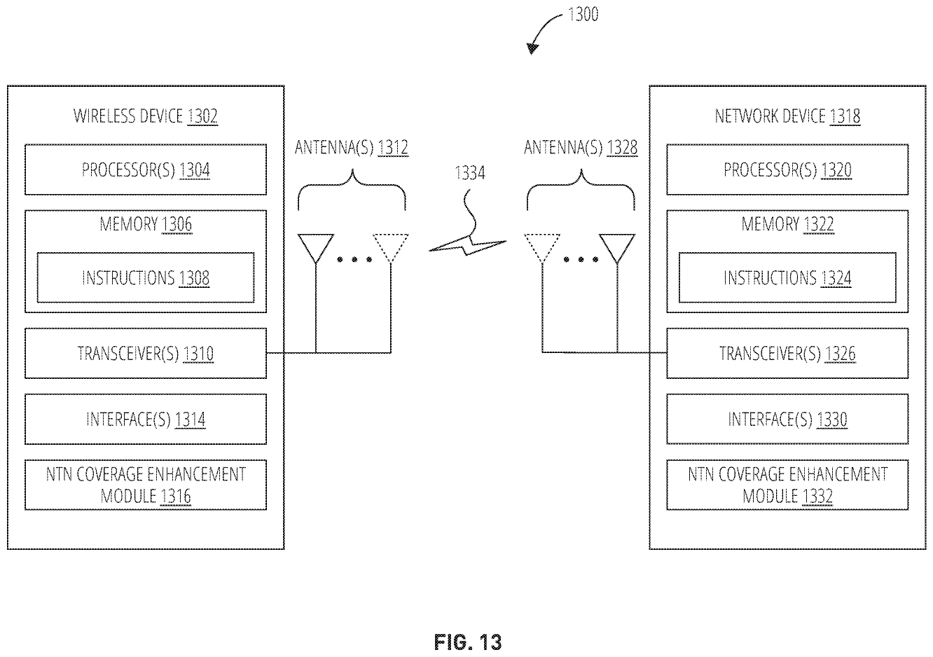

FIG. 13 illustrates a system 1300 for performing signaling 1334 between a wireless device 1302 and a network device 1318, according to embodiments disclosed herein. The system 1300 may be a portion of a wireless communications system as herein described. The wireless device 1302 may be, for example, a UE of a wireless communication system. The network device 1318 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter and/or receiver circuitry that use the antenna(s) 1312 of the wireless device 1302 to facilitate signaling (e.g., the signaling 1334) to and/or from the wireless device 1302 with other devices (e.g., the network device 1318) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include an NTN coverage enhancement module 1316. The NTN coverage enhancement module 1316 may be implemented via hardware, software, or combinations thereof. For example, the NTN coverage enhancement module 1316 may be implemented as a processor, circuit, and/or instructions 1308 stored in the memory 1306 and executed by the processor(s) 1304. In some examples, the NTN coverage enhancement module 1316 may be integrated within the processor(s) 1304 and/or the transceiver(s) 1310. For example, the NTN coverage enhancement module 1316 may be implemented by a combination of software components (e.g., executed by a DSP or a general processor) and hardware components (e.g., logic gates and circuitry) within the processor(s) 1304 or the transceiver(s) 1310.

The NTN coverage enhancement module 1316 may be used for various aspects of the present disclosure, for example, aspects of FIG. 1 to FIG. 6, FIG. 8, and FIG. 10.

The network device 1318 may include one or more processor(s) 1320. The processor(s) 1320 may execute instructions such that various operations of the network device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The network device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The network device 1318 may include one or more transceiver(s) 1326 that may include RF transmitter and/or receiver circuitry that use the antenna(s) 1328 of the network device 1318 to facilitate signaling (e.g., the signaling 1334) to and/or from the network device 1318 with other devices (e.g., the wireless device 1302) according to corresponding RATs.

The network device 1318 may include one or more antenna(s) 1328 (e.g., one, two, four, or more). In embodiments having multiple antenna(s) 1328, the network device 1318 may perform MIMO, digital beamforming, analog beamforming, beam steering, etc., as has been described.

The network device 1318 may include one or more interface(s) 1330. The interface(s) 1330 may be used to provide input to or output from the network device 1318. For example, a network device 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1318 may include an NIN coverage enhancement module 1332. The NTN coverage enhancement module 1332 may be implemented via hardware, software, or combinations thereof. For example, the NTN coverage enhancement module 1332 may be implemented as a processor, circuit, and/or instructions 1324 stored in the memory 1322 and executed by the processor(s) 1320. In some examples, the NTN coverage enhancement module 1332 may be integrated within the processor(s) 1320 and/or the transceiver(s) 1326. For example, the NTN coverage enhancement module 1332 may be implemented by a combination of software components (e.g., executed by a DSP or a general processor) and hardware components (e.g., logic gates and circuitry) within the processor(s) 1320 or the transceiver(s) 1326.

The NTN coverage enhancement module 1332 may be used for various aspects of the present disclosure, for example, aspects of FIG. 1, FIG. 2, FIG. 4, FIG. 7, FIG. 9, and FIG. 11.

Embodiments contemplated herein include an apparatus comprising means to perform one or more elements of the methods 300, 500, 600, 800, and 1000. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of the methods 300, 500, 600, 800, and 1000. This non-transitory computer-readable media may be, for example, a memory of a UE (such as a memory 1306 of a wireless device 1302 that is a UE, as described herein).

Embodiments contemplated herein include an apparatus comprising logic, modules, or circuitry to perform one or more elements of the methods 300, 500, 600, 800, and 1000. This apparatus may be, for example, an apparatus of a UE (such as a wireless device 1302 that is a UE, as described herein).

Embodiments contemplated herein include an apparatus comprising: one or more processors and one or more computer-readable media comprising instructions that, when executed by the one or more processors, cause the one or more processors to perform one or more elements of the methods 300, 500, 600, 800, and 1000. This apparatus may be, for example, an apparatus of a UE (such as a wireless device 1302 that is a UE, as described herein).

Embodiments contemplated herein include a signal as described in or related to one or more elements of the methods 300, 500, 600, 800, and 1000.

Embodiments contemplated herein include a computer program or computer program product comprising instructions, wherein execution of the program by a processor is to cause the processor to carry out one or more elements of the methods 300, 500, 600, 800, and 1000. The processor may be a processor of a UE (such as a processor(s) 1304 of a wireless device 1302 that is a UE, as described herein). These instructions may be, for example, located in the processor and/or on a memory of the UE (such as a memory 1306 of a wireless device 1302 that is a UE, as described herein).

Embodiments contemplated herein include an apparatus comprising means to perform one or more elements of the methods 700, 900, and 1100. This apparatus may be, for example, an apparatus of a base station (such as a network device 1318 that is a base station, as described herein).

Embodiments contemplated herein include one or more non-transitory computer-readable media comprising instructions to cause an electronic device, upon execution of the instructions by one or more processors of the electronic device, to perform one or more elements of the methods 700, 900, and 1100. This non-transitory computer-readable media may be, for example, a memory of a base station (such as a memory 1322 of a network device 1318 that is a base station, as described herein).

Embodiments contemplated herein include an apparatus comprising logic, modules, or circuitry to perform one or more elements of the methods 700, 900, and 1100. This apparatus may be, for example, an apparatus of a base station (such as a network device 1318 that is a base station, as described herein).

Embodiments contemplated herein include an apparatus comprising: one or more processors and one or more computer-readable media comprising instructions that, when executed by the one or more processors, cause the one or more processors to perform one or more elements of the methods 700, 900, and 1100. This apparatus may be, for example, an apparatus of a base station (such as a network device 1318 that is a base station, as described herein).

Embodiments contemplated herein include a signal as described in or related to one or more elements of the methods 700, 900, and 1100.

Embodiments contemplated herein include a computer program or computer program product comprising instructions, wherein execution of the program by a processing element is to cause the processing element to carry out one or more elements of the methods 700, 900, and 1100. The processor may be a processor of a base station (such as a processor(s) 1320 of a network device 1318 that is a base station, as described herein). These instructions may be, for example, located in the processor and/or on a memory of the base station (such as a memory 1322 of a network device 1318 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a network node in a non-terrestrial network (NTN), the method comprising:
transmitting an indication, from the network node to a user equipment (UE), of an uplink segmentation duration for demodulation reference signal (DMRS) bundling;
receiving, from the UE in response to the indication, a UE capability report on a maximum time domain window (TDW) duration ability of the UE and a phase difference pre-compensation ability of the UE;
scheduling a configured grant physical uplink shared channel (PUSCH) for the UE indicating a PUSCH DMRS bundling size based on the maximum TDW duration ability of the UE, the phase difference pre-compensation ability of the UE, and the uplink segmentation duration; and
performing joint channel estimation based on the PUSCH DMRS bundling size.

2. The method of claim 1, wherein the UE capability report further indicates the UE's ability for the DMRS bundling.

3. The method of claim 1, further comprising receiving an independent report of the UE's capability for the DMRS bundling.

4. The method of claim 1, wherein the UE capability report further includes a maximum value corresponding to the phase difference pre-compensation ability of the UE.

5. The method of claim 1, wherein the UE capability report is received in radio resource control (RRC) signaling.

6. The method of claim 1, wherein the UE capability report is received in a media access control (MAC) control element (CE) configured to report a capability of phase difference pre-compensation in the NTN under at least one of timing drift and Doppler shift.

7. The method of claim 1, wherein the UE capability report is received in a media access control (MAC) control element (CE) comprising a reserved bit to indicate the phase difference pre-compensation ability of the UE.

8. A method for a user equipment (UE), the method comprising:
receiving, from a network node in a non-terrestrial network (NTN), an uplink segmentation duration for demodulation reference signal (DMRS) bundling;
reporting, from the UE to the network node, a UE capability for a maximum time domain window (TDW) duration and a phase difference pre-compensation;
receiving, from the network node, scheduling information for a configured grant physical uplink shared channel (PUSCH) indicating a PUSCH DMRS bundling size; and
transmitting, from the UE to the network node, the configured grant PUSCH based on the PUSCH DMRS bundling size indicated by the network node.

9. The method of claim 8, wherein reporting the UE capability further comprises jointly reporting an ability of the UE for the DMRS bundling.

10. The method of claim 8, further comprising sending, from the UE to the network node, an independent report of the UE's capability for the DMRS bundling.

11. The method of claim 8, wherein the UE capability reported from the UE to the network node further includes a maximum value of the phase difference pre-compensation.

12. The method of claim 8, wherein reporting the UE capability comprises sending, from the UE to the network node, the UE capability in radio resource control (RRC) signaling.

13. The method of claim 8, wherein reporting the UE capability comprises sending, from the UE to the network node, a media access control (MAC) control element (CE) configured to report a capability of the phase difference pre-compensation in the NTN under at least one of timing drift and Doppler shift.

14. The method of claim 8, wherein reporting the UE capability comprises sending, from the UE to the network node, a media access control (MAC) control element (CE) comprising a reserved bit to indicate an ability by the UE to perform the phase difference pre-compensation.

15. A method for a network node in a non-terrestrial network (NTN), the method comprising:
transmitting an indication, from the network node to a user equipment (UE), of an uplink segmentation duration for demodulation reference signal (DMRS) bundling;
receiving, from the UE in response to the indication, a UE capability report on a maximum time domain window (TDW) duration ability of the UE and a phase difference pre-compensation ability of the UE;
scheduling a configured grant physical uplink shared channel (PUSCH) for the UE indicating a PUSCH DMRS bundling size based on the maximum TDW duration ability of the UE and the uplink segmentation duration; and
performing joint channel estimation based on the PUSCH DMRS bundling size and the phase difference pre-compensation ability reported by the UE.

16. The method of claim 15, wherein the UE capability report further indicates the UE's ability for the DMRS bundling.

17. The method of claim 15, further comprising receiving an independent report of the UE's capability for the DMRS bundling.

18. The method of claim 15, wherein the UE capability report further includes a maximum value corresponding to the phase difference pre-compensation ability of the UE.

19. The method of claim 15, wherein the UE capability report is received in radio resource control (RRC) signaling.

20. The method of claim 15, wherein the UE capability report is received in a media access control (MAC) control element (CE) configured to report a capability of phase difference pre-compensation in the NTN under at least one of timing drift and Doppler shift.

21-30. (canceled)
